(19) United States
(12) Patent Application Publication
(10) Pub. No.: US 2021/0143582 A1
(43) Pub. Date: May 13, 2021

(54) PLUG CONNECTOR

(71) Applicant: Stäubli Electrical Connectors AG, Allschwil (CH)

(72) Inventors: Christian HENGEL, Hochstatt (FR); Louis DELORENZI, Blodelsheim (FR); Olivier JUND, Schlierbach (FR)

(73) Assignee: Stäubli Electrical Connectors AG, Allschwil (CH)

(21) Appl. No.: 17/045,879

(22) PCT Filed: Apr. 16, 2019
(86) PCT No.: PCT/EP2019/059798

§ 371 Date: Oct. 7, 2020

(30) Foreign Application Priority Data
Apr. 18, 2018 (EP) 18168000.0

(51) Int. Cl. H01R 13/64; H01R 13/631

(52) U.S. Cl. CPC H01R 13/64; H01R 13/631

(57) ABSTRACT

A connector (2) for establishing a plug connection with a mating connector (3) comprises at least one guiding element (21) for guiding the plugging together of the connector (2) with the mating connector (3) and at least one orientation structure (25; 27). The guiding element (21) has an elongated design and protrudes from the connector (2) along an extension direction (E) and the orientation structure (25; 27) is configured to provide a rotation lock with a complementary orientation structure (24; 37) provided on the mating connector (3) with respect to a rotation of the connector (2) relative to the mating connector (3) upon connection of the connector (2) and the mating connector (3). A connector system (1) comprises such a connector (2) and a mating connector (3), the mating connector (3) comprising at least one receptacle (31) for receiving the at least one guiding element (21) of the connector (2).

### TECHNICAL FIELD

The present invention relates to a connector for establishing a plug connection with a mating connector and a connector system comprising such a connector and a mating connector according to the preamble of claims 1 and 10, respectively.

### PRIOR ART

Connector systems comprising a connector and a mating connector are widely used in order to interface system components with each other or with other systems. For example, connector systems comprising a pin-side connector and a socket-side connector can be used in order to provide an electrical contact or to establish a fluid-tight connection in fluidic systems. A proper alignment of the connectors can however be difficult.

From U.S. Pat. No. 4,998,892 a connection system with a plug connector and a receptacle connector are known, in which a guiding function is provided by means of guide pins on the connector that enter holes in the receptacle connector.

However, it is not only desirable to connect the connector and the mating connector in a properly aligned manner, but to also keep them in a properly aligned state once they are connected.

### SUMMARY OF THE INVENTION

It is therefore an object to provide an improved connector for establishing a plug connection with a mating connector. In particular, it is an object to provide a connector that enables a durable reliable plug connection with a mating connector.

This object is achieved with a connector according to claim 1. In particular, in a first aspect a connector for establishing a plug connection with a mating connector by plugging together the connector with the mating connector along a plugging direction is provided, wherein the connector comprises at least one connector element that is arranged to establish a functional contact with a respective connector element provided on the mating connector. The connector further comprises at least one guiding element for guiding the plugging together of the connector with the mating connector along the plugging direction and at least one orientation structure. The guiding element has an elongated design and protrudes from the connector along an extension direction. The at least one orientation structure is configured to provide a rotation lock with at least one complementary orientation structure provided on the mating connector with respect to a rotation of the connector relative to the mating connector upon connection of the connector and the mating connector.

That is to say, the protruding guiding element serves the purpose of guiding the connector upon its connection with the mating connector. Said guidance enables a targeted connection, in which the connector is properly placed in relation to the mating connector. The guiding element can thus also be seen as a centering aid. Properly placed in the present context means that any misalignment between the connector and the mating connector is reduced or even prevented, and wherein the connector is arranged horizontally and/or vertically and/or angularly aligned with respect to the mating connector such that a stable and functional connection, and as a result, a reliable connection with the mating connector is achieved. Furthermore, the at least one orientation structure prevents a rotation of the connector with respect to the mating connector and thus keeps the connectors in their aligned state. The term rotation lock in the present context means that a protection against rotation, twisting, or torsion of the connector relative to the mating connector is provided. To a certain extent, said connector satisfies a dual function, namely it provides a guiding function as wells as an anti-rotating function at the same time.

The connector could correspond to an electrical or a fluidic connector. The functional contact established between the connector and the mating connector can then be an electrical contact or a fluidic contact. In the former case, the connector and the mating connector correspond to a pin-side connector and a socket-side connector, wherein the connector elements provided on said connectors are electrical pins and electrical sockets, respectively. In the latter case, the connector and the mating connector correspond to an inlet-side connector and an outlet-side connector, wherein the connector elements correspond to fluid path inlets and fluid path outlets provided on said connectors which allow a fluid communication or connection between said fluid paths. However, different types of connectors are conceivable. Possible connections established by the connector and the mating connector are not only electrical or fluidic, but also thermocouple pressure contacts, coaxial, optical fiber, compressed air, liquid, electrical and PE, or data transfer, respectively.

It is preferred that the at least one orientation structure is not completely rotationally symmetrical with respect to a rotation about a rotation axis extending centrally through the orientation structure. That is, the orientation structures of the connector and the mating connector are preferably provided by means of mutually complementary asymmetrical shapes that enter into a preferably form-locking connection with one another upon connection of the connector and the mating connector. Asymmetrical shape in the present context means that said shape is designed such that the orientation structure is solely transferred into itself in the case of rotations about the rotation axis through certain angles, but not through any angle. In other words, the orientation structure when viewed in the cross-section is rotationally symmetrical with respect to rotations through certain angles only. Thus, the at least one orientation structure is preferably not completely rotationally symmetrical. Examples of conceivable asymmetrical shapes are a square shape, which is rotationally symmetrical with respect to rotations by 90 degrees, a rectangular shape, which is rotationally symmetrical with respect to rotations by 180 degrees, or a completely asymmetrical shape such as e.g. a droplet shape, which is only rotationally symmetrical with respect to a rotation by 360 degrees. Hence, the orientation structures can be provided by means of said mutually complementary asymmetrical shapes. Moreover, the asymmetric design also serves the purpose of a coding which ensures a correct plugging together of the two connectors. In fact, the asymmetric shape allows a connection of the connector with the mating connector in one single orientation only.

The at least one orientation structure of the connector can be configured to form a positive fit and/or a force fit with the at least one orientation structure of the mating connector upon connection of the connector and the mating connector. The connector and the mating connector can thus engage one another due to their orientation structures. An example of such orientation structures are a tongue and a groove according to a tongue-and-groove connection, wherein the tongue could be provided on the connector and a corresponding groove could be provided on the mating connector, or vice versa.

The at least one orientation structure preferably comprises a first orientation structure, wherein the first orientation structure is integrally formed on the guiding element. The first orientation structure can be provided by means of at least one guiding surface, which guiding surface is configured to cooperate with a correspondingly shaped guiding surface provided on the mating connector. For example, the guiding element can be provided in the form of an essentially cylindrical bar, preferably with a conically tapering tip, wherein the guiding surface on the guiding element is provided by means of a straight cutting surface which slides along or past the guiding surface provided on the mating connector, as will be explained in greater detail below.

The at least one orientation structure preferably comprises a second orientation structure, wherein the second orientation structure is designed as a recess extending into the connector or the second orientation structure of the connector can be designed as a sheath element protruding from the connector. If the second orientation structure of the connector is designed as a sheath element protruding from the connector, the mutually complementary second orientation structure of the mating connector will therefore be designed as a recess extending into the mating connector. Likewise, if the second orientation structure of the connector is designed as a recess extending into the connector, the mutually complementary second orientation structure of the mating connector will therefore be designed as a sheath element protruding from the mating connector. The protruding sheath element of the connector (mating connector) will therefore be received within the recess of the mating connector (connector) upon connection of the connectors. It should be noted that the second orientation structures can be provided on the connector and mating connector in addition to the first orientation structures or instead of the first orientation structures. That is, it is conceivable to provide a connector and a mating connector that comprise either the first orientation structures or the second orientation structures only, or that comprise both the first and second orientation structures.

One guiding element can be arranged at least partly within the second orientation structure of the connector and/or one or more guiding elements can be laterally spaced apart from the second orientation structure of the connector.

That is, it is conceivable to provide one single guiding element only, wherein said guiding element is preferably arranged at least partly within the second orientation structure of the connector. However, it is likewise conceivable to provide one or more guiding elements that are laterally spaced apart from the second orientation structure of the connector, for example that are laterally arranged on the connector housing of the connector, wherein no guiding element is arranged within the second orientation structure. Though, said one or more guiding elements can also be provided in addition to a guiding element arranged within the second orientation structure.

It is preferred that the guiding element extends beyond the second orientation structure when viewed along the extension direction.

In other words, it is preferred that the length of the guiding element or the guiding elements is greater than the length of the second orientation structure, i.e. that the guiding element(s) protrude over the second orientation structure. In this way, a guiding element can be at least partly received within the second orientation structure. This design has the effect that a first contact is established between the guiding element and the mating connector, which results in a guided connection, and that a second contact is subsequently established between the second orientation structures of the guiding elements upon further connection, which results in a protection against rotation and thus in a durable aligned connection.

The connector can further comprise at least one resilient element for resiliently mounting the connector on a support, the resilient element being preferably configured to compensate a vertical offset and/or a horizontal offset and/or an angular offset of the connector with respect to the mating connector upon connection of the connector and the mating connector. To this end the resilient element is preferably made of an elastic, flexible or deformable material or configuration which permits a deformation or movement of the connector in all directions in space. In this way one single resilient element can be provided, said resilient element being arranged centrally on the connector housing of the connector. Said one single resilient element could be a spring or a resilient element in the form of a double loop as described below which is arranged centrally with respect to the outer walls of the connector housing and on the opposite side of the guiding element on the connector. Or at least two resilient elements can be provided, said resilient elements being preferably arranged symmetrical on the connector housing, e.g. in corner areas of the connector housing. The resilient element preferably has essentially the shape of a double loop, wherein the loops are arranged offset by about 90 degrees with respect to each other and, with respect to the fastening thereof on the connector housing, are arranged one behind the other. Each loop can have one fastening element by means of which the first loop can be connected to the connector housing and the second loop is connectable to the support. Either configuration of the resilient element(s) is in the position of compensating a vertical offset, a horizontal offset as well as an angular offset of the connector with respect to the mating connector upon connection thereof. In fact, during the connection of the connector with the mating connector the resilient element(s) allows the connector to tilt downwards, upwards and sideways with respect to the mating connector and, as such, a tolerance compensation in several spatial dimensions. The tilting is caused by the interaction between the guiding element and a receptacle on the mating connector, as will be explained in greater detail below.

In a second aspect a connector system comprising a connector according to the description above and a mating connector is provided, wherein the mating connector comprises at least one connector element that is arranged to establish a functional contact with the respective connector element provided on the connector. The mating connector further comprises at least one receptacle for receiving the at least one guiding element of the connector, and at least one orientation structure that is designed complementary to the at least one orientation structure of the connector in order to provide a rotation lock with respect to a rotation of the connector relative to the mating connector upon connection of the connector and the mating connector.

Firstly, it should be noted that any configurations of the connector described herein below with respect to the second aspect of the present invention can be found on the connector according to the first aspect described above, and vice versa.

That is, a connector system comprising a connector and a correspondingly designed mating connector are provided, wherein the mating connector comprises a receptacle within which the guiding element on the connector is received in a guided manner upon connection of the connector and the mating connector. That is to say, the protruding guiding element serves the purpose of guiding the connector upon its connection with the mating connector. Said guidance enables a targeted connection, in which the connector is properly placed in relation to the mating connector. In this way a mechanically and functionally reliable connection between the connector and the mating connector is provided, which remains so on a permanent basis, i.e. throughout the period in which the connectors are connected.

As outlined above, the connector system can be an electrical plug connector system with a connector and a mating connector corresponding to a pin-side connector and a socket-side connector, wherein the connector elements provided on said connectors are electrical pins and electrical sockets, respectively. However, it is likewise conceivable that the connector system is a fluidic plug connector system, where the connector and the mating connector correspond to an inlet-side connector and an outlet-side connector, and where the connector elements correspond to fluid path inlets and fluid path outlets provided on said connectors which allow a fluid communication or connection between said fluid paths. As already mentioned, other types of connectors, such as connectors establishing thermocouple pressure contacts, coaxial, optical fiber, compressed air, liquid, electrical and PE, or data transfer connections, are however possible, too.

It is preferred that the guiding element has one or more chamfers which are configured to slide along an inner surface of the receptacle upon connection of the connector and the mating connector so as to enable a guided receiving of the guiding element within the receptacle. Here, the chamfers correspond to inclined surfaces which are preferably provided on a free end region of the guiding element, e.g. the chamfers can be formed by means of a tapering tip of the guiding element.

The second orientation structure of the connector and the receptacle of the mating connector in each case preferably comprise free end regions having mutually corresponding inclined end surfaces, which inclined end surfaces enable a guided receiving of the guiding element within the receptacle.

The at least one orientation structure of the mating connector preferably comprises a first orientation structure, wherein said first orientation structure is a guiding surface provided on the receptacle and being correspondingly shaped with respect to the first orientation structure in the form of a guiding surface provided on the guiding element so as to enable a guided receiving of the guiding element within the receptacle.

This means that in addition to the guided connection of the connectors by means of the guiding element being received in the receptacle and the inclined end surfaces on the free end regions and the chamfers on the guiding element, respectively, there is a further guiding achieved by means of the guiding surfaces provided on the guiding element and the receptacle. The insertion of the guiding element into the receptacle can in a sense be considered as a rough adjustment, which is mainly important for a proper positioning between the connectors. To this end the receptacle preferably has a shape that essentially corresponds to the shape of the guiding element. For example, the guiding element can be provided in the form of an essentially cylindrical bar, preferably with a conically tapering tip, and the receptacle can be of a cylindrical shape. The further guidance by means of the guiding surfaces can be considered as a precision adjustment, wherein the guiding surface of the receptacle can be provided by means of a guiding pin arranged within the receptacle, wherein the guiding pin is arranged offset with respect to a central axis of the receptacle and preferably extends through the clear width of the receptacle transversely with respect to the central axis, and/or wherein the guiding pin is arranged in a proximal region of the receptacle. The combination of adjustments results in an even more precise guidance. The guiding surface on the guiding element is preferably provided by means of the straight cutting surface mentioned above, which slides along or past the guiding surface provided on the receptacle. In the example of the cylindrically shaped guiding element the guiding surface could be provided by means of partially cutting-off the lateral surface of the cylinder in the circumferential direction and essentially fully cutting-off said lateral surface in the longitudinal direction of the guiding element. The straight cutting surface that is created in this way then corresponds to the said guiding surface of the guiding element. The guiding surface of the guiding element thereby preferably extends essentially along an entire length of the guiding element. In this way the guiding element can be received within the receptacle upon the connection of the connector with the mating connector in a guided manner over substantially its entire length. However, it is also conceivable that the receptacle has a guiding slot into which a guiding element in the form of a tongue or the like or a protruding element that protrudes from the guiding element, respectively, is received upon the connection, such that guidance is provided by means of the guiding slot interacting with the protruding element. Further configurations such as a receptacle having a semi-circular cross-section, wherein the guiding element can be guided along the straight surface of said semi-circular receptacle upon the connection of the connectors, are possible as well. Besides, it should be noted that these and similar configurations not only serve the purpose of guiding the connection between the connector and the mating connector, but can also provide the above-mentioned rotation lock and are also coding means which ensure that the connector is connected to the mating connector in the correct orientation. In particular, by choosing the sum of the cross-sections of the guiding pin and the guiding element in the region of their guiding surfaces such that said sum essentially corresponds to the diameter of the receptacle in the region of the guiding pin, a positive-locking fit is established and a rotation lock is thus provided.

It is preferred that the at least one orientation structure of the mating connector comprises a second orientation structure being provided by means of the receptacle itself.

The guiding element preferably extends essentially perpendicularly with respect to a surface of the connector, and/or the second orientation structure of the connector is preferably constituted by walls that extend essentially perpendicularly with respect to the surface of the connector, and/or the second orientation structure of the mating connector is preferably constituted by walls that extend essentially perpendicularly with respect to a surface of the mating connector.

That is, it is preferred that the guiding element, and thus also the receptacle, and the second orientation structures in each case extend essentially perpendicularly and therefore not inclined or tilted from a surface of the connector and the mating connector, respectively. The same thus applies to the walls constituting said second orientation structures, both when the second orientation structures are designed as a recess extending into the connector (mating connector) and as a sheath element protruding from the connector (mating connector) as described above. To this end it is however preferred that the free end regions of the second orientation structures on the connector and the mating connector comprise mutually corresponding inclined end surfaces as mentioned above, which end surfaces provide an additional guidance upon the connection of the connector with the mating connector. At the same time, said end surfaces also serve for tolerance compensation, since an alignment of the two connectors with respect to one another during the sliding along the end surfaces takes place.

The surface of the connector and the surface of the mating connector are preferably essentially flush with one another when the plug connection is established between the connector and the mating connector. To this end, the receptacle on the mating connector should be dimensioned such that the guiding element can be completely received therein. Equally, the second orientation structure in the form of a recess should be dimensioned such that the second orientation structure in the form of a protruding sheath element can be completely received therein. In this way, a tight connection between the connectors can be established.

The guiding element can be electrically conductive and can be configured for electrically contacting the receptacle on the mating connector, wherein a resilient contact element such as a contact lamella is arranged within the receptacle in order to establish an electrical contact. In this case, the guiding element also serves the purpose of an earthing contact, i.e. a contact element for grounding. It should be noted that instead of a contact lamella any other resilient contact element could be arranged within the receptacle. However, it is likewise conceivable that the guiding element is non-conductive and serves solely for guiding.

The guiding element and the connector elements are preferably arranged in one or more sub-housings, the sub-housings being removably mounted within the connector housing of the connector, and/or the receptacle and one or more connector elements are preferably arranged in one or more sub-housings, the sub-housings being removably mounted within the mating connector housing of the mating connector. That is to say, the connector elements, e.g. the pins and the sockets, as well as the guiding element and the receptacle can be arranged in sub-housings which in turn are removably mounted within the connector housing of the connector and within the mating connector housing of the mating connector, respectively. In this case the connector system corresponds to a modular connector system in which the connector elements, the guiding element and the receptacle can be replaced by removing the particular sub-housings they are arranged in. One or more connector elements can be arranged on the same sub-housings. For example it is possible to arrange connector elements of the same type or of the same dimensions in one common sub-housing. However, it is likewise conceivable to arrange only one connector element per sub-housing or to arrange a plurality of different connector elements in one common sub-housing. However, it should be noted that the connector system could also correspond to a non-modular system, wherein all connector elements are an integral part of the same connector housing. In addition, it is conceivable that the connector comprises sub-housings which do not contain any connector elements. Such empty sub-housings serve the purpose of a spacer or a distance piece.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows a perspective view of a plug connector comprising a connector and a mating connector;

FIG. 2 shows a further perspective view of the plug connector according to FIG. 1;

FIG. 3 shows a side view of the plug connector according to FIG. 1 in an unconnected state;

FIG. 4 shows a longitudinal section of the plug connector according to FIG. 3 through the plane A-A.

FIG. 5 shows a top view of the plug connector according to FIG. 1 in the unconnected state;

FIG. 6 shows a longitudinal section of the plug connector according to FIG. 5 in the unconnected state through the plane B-B;

FIG. 7 shows a longitudinal section of the plug connector according to FIG. 3 in a semi-connected state through the plane A-A;

FIG. 8 shows a longitudinal section of the plug connector according to FIG. 5 in the semi-connected state through the plane B-B;

FIG. 9 shows a longitudinal section of the plug connector according to FIG. 3 in a connected state through the plane A-A;

FIG. 10 shows a longitudinal section of the plug connector according to FIG. 5 in the connected state through the plane B-B;

FIG. 11 shows a perspective view of a sub-housing comprising a sheath element according to a first embodiment;

FIG. 12 shows a side view of the sub-housing comprising the sheath element according to FIG. 11;

FIG. 13 shows a sectional view of the sub-housing comprising the sheath element according to FIG. 12 through the plane C-C;

FIG. 14 shows a perspective view of a sub-housing comprising a sheath element according to a second embodiment;

FIG. 15 shows a side view of the sub-housing comprising the sheath element according to FIG. 14;

FIG. 16 shows a sectional view of the sub-housing comprising the sheath element according to FIG. 15 through the plane D-D.

### DESCRIPTION OF PREFERRED EMBODIMENTS

In FIGS. 1 to 10 a connector system 1 comprising a connector 2 and a mating connector 3 are depicted in different connection states. In the present example, the connector system 1 corresponds to an electrical connector system, where the connector is provided in the form of a pin-side connector 2 and the mating connector is provided in the form of a socket-side connector 3. It should be noted that this could likewise be reversed, i.e. that the connector corresponds to a socket-side connector and the mating connector corresponds to a pin-side connector. In particular, FIGS. 1 to 6 depict the connector system 1 in the unconnected state, in which the pin-side connector 2 and the socket-side connector 3 are separated from one another. In the semi-connected state as depicted in FIGS. 7 and 8, the pin-side connector 2 has been partly connected to the socket-side connector 3 along a plugging direction P, whereas FIGS. 9 and 10 depicted the connector system 1 in the connected state, in which the pin-side connector 2 has been fully connected to the socket-side connector 3. In the following, the pin-side connector 2 and the socket-side connector 3 are discussed in detail.

As best seen in FIGS. 1 and 2, the pin-side connector 2 and the socket-side connector 3 in each case comprises a connector housing 23, 33, which is delimited by outer walls 231, 331 and which has an essentially rectangular shape. A plurality of connector elements in the form of electrical pins 22a, 22b, . . . and sockets 32a, 32b, . . . is provided within the pin-side connector housing 2 and the socket-side housing 3, respectively. In each case one pin 22a, 22b, . . . on the pin-side connector 2 is configured to establish an electrical contact with a corresponding socket 32a, 32b, . . . on the socket-side connector 3. Moreover, a guiding element 21 in the form of a protruding bar for guiding the plugging together of the pin-side connector 2 and the socket-side connector 3 is arranged centrally on the pin-side connector 2 with respect to the outer walls 231 of the pin-side connector housing 23. Said guiding element 21 has an elongated design and extends perpendicularly away from a surface 210 of the pin-side connector 2 along an extension direction E. A receptacle 31 configured to receive said guiding element 21 is provided on the socket-side connector 3, wherein said receptacle 31 is likewise arranged centrally on the socket-side connector 3 with regard to the outer walls 331 of the socket-side connector housing 33. To this end, the guiding element 21 is arranged centrally with respect to the outer walls 231 of the pin-side connector housing 23 as well as centrally within all of the pins 22a, 22b, . . . provided on the pin-side connector 2. In the present case two additional guiding elements 216a, 216b are arranged laterally on the pin-side connector housing 23, which additional guiding elements 216a, 216b are configured to be received in corresponding openings 316a, 316b arranged laterally on the socket-side connector housing 33. Said additional guiding elements 216a, 216b provide additional guidance upon the connection of the pin-side and the socket-side connectors 2, 3 and thereby assist the proper adjustment of the connectors 2, 3 with respect to each other especially at the end of the connecting process. Different types of pins 22a, 22b, . . . are provided which are arranged in different groups 221a, 221b, . . . on the pin-side connector 2. In the present example, the pin-side connector 2 comprises medium-sized pins 22a constituting a first and a second group of pins 221a, 221b, thin pins 22b constituting a third and a fourth group of pins 221c, 221d, and large pins 22c constituting a fifth and a sixth group of pins 221e, 221f, wherein the guiding element 21 is arranged centrally within said groups 221a, 221b, . . . . The distance between the guiding element 21 and the first group of pins 221a equals the distance between the guiding element 21 and the second group of pins 221b. Likewise, the distances between the guiding element 21 and the third group 221c and the fifth group 221e equal the distances between the guiding element 21 and the fourth group 221d and the sixth group 221f, respectively. In other words, the first, third and fifth groups of pins 221a, 221c, 221e and the second, fourth and sixth groups of pins 221b, 221d, 221f are arranged mirror-symmetrical with respect to a plane extending vertically through the guiding element 21. In an analogous manner, the receptacle 31 is arranged centrally with respect to the outer walls 331 of the socket-side connector housing 33 as well as centrally within all of the sockets 32a, 32b, . . . provided on the socket-side connector 3, wherein different types of sockets 32a, 32b, . . . are arranged in different groups of connector elements 321a, 321b, . . . in a mutually corresponding manner with respect to the arrangement of the groups of pins 221a, 221b, . . . on the pin-side connector 2. It should be noted again that the number of as well as the arrangement of the connector elements are not limited to the example shown in the figures. Instead, a plurality of arrangements is possible.

Two resilient elements 24a, 24b in the form of double loops 241a, 242a, 241b, 242b are arranged in the corner areas of the pin-side connector housing 23 in order to resiliently mount the pin-side connector housing 23 on a support. Each loop 241a, 242a, 241b, 242b has one fastening element 243a, 243b, 244a, 244b by means of which the first loop 241a, 241b is connected to the pin-side connector housing 23 and the second loop 242a, 242b is connectable to the support. The loops 241a, 242a, 241b, 242b are arranged offset by about 90 degrees with respect to each other and are arranged one behind the other with respect to the fastening of the resilient element 24a, 24b on the pin-side connector housing 23, giving the resilient elements 24a, 24b the shape of a twisted “8”. In particular, that loop 241a, 241b, which is arranged proximal from the pin-side connector housing 23 and is connected thereto and, in the present case, in a lateral view of the connector system 1 has the shape of a standing zero is elastically deformable particularly in the vertical direction V, whereas that loop 242a, 242b, which is arranged distal from the pin-side connector housing 23 and, in the present case, in the lateral view of the connector system 1 has the shape of a lying zero is elastically deformable particularly in the horizontal direction H.

Due to this configuration the resilient element 24a, 24b is in the position of compensating a vertical offset, a horizontal offset as well as an angular offset of the pin-side connector 2 with respect to the socket-side connector 3 upon connection thereof. That is, during the connection of the pin-side connector 2 with the socket-side connector 3 the resilient element 24a, 24b allows the pin-side connector 2 to tilt downwards, upwards and sideways with respect to the socket-side connector 3. The tilting is caused by the interaction between the guiding element 21 and the receptacle 31, which interaction also defines the absolute value and the direction of the tilting. This allows tolerance compensation in several spatial dimensions.

As best seen in FIGS. 6, 8 and 10, the guiding element 21 and the receptacle 31 in each case comprises at least one guiding surface 25, 34, wherein the guiding surface 25 of the guiding element 21 and the guiding surface 34 of the receptacle 31 are correspondingly shaped so as to enable a guided receiving of the guiding element 21 within the receptacle 31. In fact, the guiding element 21 has in the present case an essentially cylindrical shape with a conically tapering tip 211. The lateral surface of the cylindrical guiding element 21 however has been partially cut-off in the circumferential direction and has been essentially fully cut-off in the longitudinal direction. The straight cutting surface that is created in this way corresponds to the said guiding surface 25 of the guiding element 21. The guiding element 21 along with its guiding surface 25 thus has to a certain extent the shape of a cylinder segment. The guiding surface 34 of the receptacle 31 is provided by means of a guiding pin 35 that is arranged within the receptacle 31, in a proximal region 36 of the receptacle 31. The proximal region 36 refers to that region of the receptacle 31 within which the guiding element 21 is firstly received upon connection thereof. Furthermore, the guiding pin 35 is arranged offset with respect to a central axis AR of the receptacle 31 and extends through the clear width of the receptacle 31 transversely with respect to the central axis AR. In other words, the guiding pin 35 is arranged at a right angle to the central axis AR of the receptacle 31 and offset upwards within the receptacle 31 when the socket-side connector 3 is viewed from the front. It follows from FIGS. 9 and 10 that the length LG of the guiding surface 25 on the guiding element 21 corresponds approximately to the length LR of an inner lateral surface 310 of the receptacle 31. In this way the guiding element 21 can be received within the receptacle 31 upon the connection of the pin-side connector 2 with the socket-side connector 3 in a guided manner over substantially its entire length, whereby guidance in the horizontal direction H is provided. Guidance in the vertical direction V is achieved by the particular dimensions of the guiding pin 35 and the guiding element 21, wherein the sum of the cross-sections of the guiding pin 35 and the guiding element 21 along the vertical direction V in the region of the guiding surfaces 25, 34 corresponds essentially to the diameter of the receptacle 31 in the region of the guiding pin 35. Thereby, also a rotation of the connector 2 with respect to the mating connector 3 is prevented, i.e. the guiding surfaces 25, 34 correspond to first orientation structures which provide a rotation lock.

The connector elements, i.e. the pins 22a, 22b, . . . and the sockets 32a, 32b, . . . , as well as the guiding element 21 and the receptacle 31 are arranged in sub-housings 232, 232a, 232b, . . . 332, 332a, 332b, . . . which in turn are removably mounted within the connector housings 23, 33 of the pin-side and the socket-side connector 2, 3, respectively. The present connector system 1 is thus a modular connector system in which the connector elements 22a, 22b, 32a, 32b, . . . , the guiding element 21 and the receptacle 31 can be replaced by removing the particular sub-housings 232, 232a, . . . 332, 332a, . . . they are arranged in. Moreover, it should be noted that outer housings (not shown) at least partly surrounding the connector housings 23, 33 and the connector elements 22a, . . . , 32a, . . . can be provided, too, which outer housings in each case shield and protect the connector 2 and the mating connector 3 from the surroundings. In the present example, seven sub-housings 232, 232a, . . . are mounted on the pin-side connector 2 and seven sub-housings 332, 332a, . . . are mounted on the socket-side connector 3. The sub-housing 232, 332 arranged centrally on the pin-side and the socket-side connector 2, 3 comprises the guiding element 21 and the receptacle 31, respectively. In each case the remaining six sub-housings 232a, . . . 332a, . . . comprise one of the groups 221a, . . . 321a, . . . of different pins 22a, . . . and sockets 32a, . . . as mentioned above.

Within the sub-housings 232a, . . . 332a, . . . the connector elements 22a, . . . , 32a, . . . are locked by means of a retaining clip 212, 311. The retaining clip 212, 311 is essentially U-shaped and is configured to be inserted through an opening 213a, . . . , 312a, . . . provided in the sub-housing 232a, . . . , 332a, . . . . The connector elements 22a, . . . 32a, . . . in turn have in their outer surface in each case one lateral recess or groove 214a, . . . , 313a, into which the free ends of the U-shaped retaining clip 212, 311 can engage. In this way the connector elements 22a, . . . , 32a, . . . can be mounted within the sub-housings 232a, . . . , 332a, . . . in a rotationally fixed manner. The guiding element 21 and the receptacle 31 likewise comprise such lateral recesses or grooves 214, 313 and are fastened to their sub-housing 232, 332 via an opening 213, 312 in this manner, too.

As best seen in FIGS. 1 and 2, the guiding element 21 is surrounded by a sheath element 26. In the present case, said sheath element 26 is an integral part of the particular sub-housing 232 and is formed as a recess extending into the connector, wherein said recess is delimited by the inner walls 234 of the sub-housing 232. The sheath element 26 of the guiding element 21 is designed complementary to the receptacle 31 on the socket-side connector 3. This in turn means that the receptacle 31 has the form of a sheath element protruding from the sub-housing 332. On the basis of this design the sub-housings 232, 332 of the guiding element 21 and of the receptacle 31 can be displaced along the plugging direction P relative to one another and into one another in such a way that, in the connected state, the mutually facing surfaces 233, 333 of the sub-housings 232, 332 on the pin-side connector 2 and on the socket-side connector 3 directly adjoin one another and are flush and in alignment with one another.

With regard to FIGS. 11 to 16 the sheath elements 26, 31 are discussed in more detail. As already mentioned, said sheath elements are of a complementary design. Moreover, the sheath element 26 of the guiding element 21 and the receptacle 31 in each case also comprise a second orientation structure 27, 37, the second orientation structures 27, 37 being configured such that a rotation lock with respect to a rotation of the pin-side connector 2 and the socket-side connector 3 is provided upon the connection thereof, and especially in the connected state thereof. To this end, the sheath element 26 of the guiding element 21 and the receptacle 31 are of a mutually complementary asymmetrical shape, here in the form of a droplet, wherein the above-mentioned second orientation structures 27, 37 are provided by means of said mutually complementary asymmetrical shape. That is to say, in the present example the second orientation structures 27, 37 are an integral part of the sheath element 26 and of the receptacle 31, wherein the second orientation structures 27, 37 are formed by the particular shapes of the sheath element 26 and of the receptacle 31 themselves. Namely, if the pin-side connector 2 and the socket-side connector 3 are at least partially connected, the sheath element 26 of the guiding element 21 and the receptacle 31 engage in one another and due to their asymmetric configuration a rotation relative to one another is rendered impossible. Moreover, the asymmetric design also serves the purpose of a coding which ensures a correct plugging together of the two connectors 2, 3. In fact, the asymmetric shape allows a connection of the pin-side connector 2 with the socket-side connector 3 in one single orientation, namely the correct orientation, only.

In the present example, the guiding surfaces 25, 34, and therefore the first orientation structures, and the sheath elements 26, 31 and therefore the second orientation structures 27, 37 are not completely rotationally symmetrical with respect to a rotation about a rotation axis R extending centrally through said orientation structures. In fact, the droplet shape of the sheath elements makes said sheath elements being rotationally symmetrical with respect to a rotation by 360 degrees only. Moreover, the second orientation structure 27 of the connector 2 is designed here as a recess extending into the connector 2 (see FIGS. 14-16), whereas the second orientation structure 37 of the mating connector 3 is designed as a sheath element protruding from the mating connector 3 (see FIGS. 11-13). As has already been mentioned, the second orientation structure 27 of the connector 2 is thereby constituted by walls 234 that extend essentially perpendicularly with respect to the surface 210 of the connector 2. Equally, the second orientation structure 37 of the mating connector 3 is constituted by walls 334 that extend essentially perpendicularly with respect to a surface 333 of the mating connector 3. Moreover, the dimensions of the sheath elements, in fact the lengths of said sheath elements, are such, that the surface 210 of the connector 2 and the surface 333 of the mating connector 3 are essentially flush with one another when the plug connection is established between the connector 2 and the mating connector 3. The length of the sheath element 26 and thus of the second orientation structure 27 is in this case such, that the guiding element 21 arranged therein extends beyond the second orientation structure 27 when viewed along the extension direction E (see e.g. FIGS. 2-10). The receptacle 31 comprises a rib or web 314 on its inner surface 315 in the region of the asymmetry, in case of a droplet shaped receptacle 31 in the region of the tip 371 of the drop. Said rib or web 314 provides the inner surface of the receptacle a circular cross-section and thereby compensates any effects resulting from the asymmetric receptacle 31 on the guiding element 21. It should be noted that one or more pins and sockets can comprise sheath elements 28a, . . . 38a, . . . (see e.g. sheath elements 38c of sockets 32c and corresponding sheath elements 28c of pins 22c in FIGS. 1 and 2) which are designed in analogy to the sheath elements of the guiding element 21 and the receptacle 31. It should further be noted that the sheath elements 28a, . . . surrounding the pins 22a, . . . serve the purpose of electrical shields that shield the pins 22a, . . . as they can be found on conventional plugs. It should be further noted that the said sheaths can not only be present on sub-housings. Instead, it is very conceivable to provide such sheaths also on non-modular connector systems, where the connector elements and the guiding element are mounted on a single support plate or single carrier that is received within the pin-side connector housing and the socket-side connector housing, respectively.

Furthermore, as becomes particularly evident from FIGS. 13 and 16, the free end region 218 of the sheath element 26 of the guiding element 21, and thus the second orientation structure 27, the free end region 219 of the retaining structure 217 arranged within said sheath element 26 and being configured to retain the guiding element 21 on the pin-side connector 2, as well as the free end region 317 of the receptacle 31, and thus the second orientation structure 37, comprise end surfaces 220, 221, 318, 319 which are inclined with respect to the extension direction E, and wherein said end surfaces 220, 221, 318, 319 are tilted in a manner complementary to one another. In particular, the sheath element 26 comprises an end region 218 with a tilted end surface 220 whose inclination is such, that a distance from said end surface 220 to the central axis AS of the sheath element 26 becomes increasingly larger when viewed from the proximal end of the pin-side connector 2 in the direction of the distal end of the pin-side connector 2 along the extension direction E. The retaining structure 217 arranged within the sheath element 26 in turn comprises an end region 219 with a tilted end surface 221 whose inclination is opposite to the inclination of the sheath element 26, namely such, that a distance from said end surface 221 to the central axis AS becomes increasingly smaller when viewed from the proximal end of the pin-side connector 2 in the direction of the distal end of the pin-side connector 2 along the extension direction E. Consequently, the receptacle 31 has a first end surface 318 which is configured to interact with the end surface 220 of the sheath element 26 and a second end surface 319 which is configured to interact with the end surface 221 of the retaining structure 217. The first end surface 318 of the receptacle 31 is inclined such, that a distance between the first end surface 318 and the central axis AR becomes increasingly smaller when viewed from the proximal end of the socket-side connector 3 in the direction of the distal end of the socket-side connector 3 along the extension direction E. On the other hand, the second end surface 319 is inclined such, that a distance between the second end surface 319 and the central axis AR becomes increasingly larger when viewed from the proximal end of the socket-side connector 3 in the direction of the distal end of the socket-side connector 3 along the extension direction E. Said inclined end surfaces 220, 221, 318, 319 not only provide an additional guidance upon the connection of the pin-side connector 2 with the socket-side connector 3, but at the same time also serve for tolerance compensation.

As has been mentioned in the beginning, FIGS. 5 and 6 depict the connector system 1 in the unconnected state, in which the pin-side connector 2 and the socket-side connector 3 are separated from one another, FIGS. 7 and 8 depict the semi-connected state, in which the pin-side connector 2 has been partly connected to the socket-side connector 3, and FIGS. 9 and 10 depicted the connector system 1 in the connected state, in which the pin-side connector 2 has been fully connected to the socket-side connector 3. During these different stages of connection various guiding effects emerge by reason of the particular design of the connector system. That is, a first guidance is provided when the guiding element 21 and the receptacle 31 have (just) entered into connection with one another. In doing so the conically tapering tip 219 of the guiding element 21, in particular its chamfers 222, slide along the inner surface 315 of the receptacle 31. Subsequently, the connection is further guided by means of the inclined end surfaces 220, 221, 318, 319 provided on the end regions of the retaining structure 217, the sheath element 26 and the receptacle 31, respectively. Once the connector 2 and the mating connector 3 are at least partially connected with one another in the semi-connected state, a further guidance then results between the guiding pin 35 arranged within the receptacle 31 and the guiding surface 25 of the guiding element 21. Thereby, a first rotation lock is established since the particular design and dimensions of the guiding surfaces 25, 34, i.e. the first orientation structures, prevent a rotation of the connector 2 relative to the mating connector 3. Another guidance is then provided between the sheath element 26 of the guiding pin 21 and the receptacle 31 when the connection is advanced and the connectors 2, 3 are first close to and then in the connected state. In fact, the asymmetric droplet shape of the sheath elements 26, 31 makes said sheath elements 26, 36 being rotationally symmetrical with respect to a rotation by 360 degrees only. As a result, a second rotation lock is provided once the sheath elements 26, 31 are at least partly connected, namely when the wall 334 delimiting the receptacle 31 is at least partly received within the wall 234 delimiting the sheath element 26. In addition, the walls 234, 334 and therefore the second orientation structures 27, 37 are dimensioned such, that a positive fit is established upon their connection, i.e. the pin-side connector 2 and the socket-side connector 3 can engage one another due to their orientation structures 27, 37. The first and second orientation structures therefore not only prevent a rotation of the pin-side connector 2 with respect to the socket-side connector 3 but also keep the connectors in their aligned state. At the same time, guidance is further supported if additional guiding elements are provided, such as the two additional guiding elements 216a, 216b provided laterally on the connector housing 23 of the pin-side connector 2, which are received within the corresponding openings 316a, 316b provided on the plug-side connector housing 33. Thus, the present connector system enables guidance over the different connecting stages of the connector 2 and the mating connector 3, whereby tolerances in the several spatial dimensions are compensate and a very reliable plug connection is established.

LIST OF REFERENCE SIGNS

| | |
|---|---|
| 1 | connector system |
| 2 | connector |
| 21 | guiding element |
| 22a, . . . | connector element |
| 221a, . . . | group of connector elements |
| 23 | connector housing |
| 231 | outer walls |
| 232, . . . | sub-housing |
| 233, . . . | surface |
| 234, . . . | wall |
| 24a, . . . | resilient element |
| 241a, . . . | loop |
| 242a, . . . | loop |
| 243a, . . . | fastening element |
| 244a, . . . | fastening element |
| 25 | guiding surface |
| 26 | sheath element |
| 27 | orientation structure |
| 28a, . . . | sheath element |
| 281a, . . . | inner lateral surface |
| 29, . . . | orientation structure |
| 291, . . . | tip |
| 210 | surface |
| 211 | tip |
| 212 | retaining clip |
| 213, . . . | opening |
| 214, . . . | groove |
| 215a, . . . | web |
| 216a, 216b | guiding element |
| 217 | retaining structure |
| 218 | end region |
| 219 | end region |
| 220 | end surface |
| 221 | end surface |
| 222 | chamfers |
| 3 | mating connector |
| 31 | receptacle |
| 32a, . . . | connector element |
| 321a, . . . | group of connector elements |
| 33 | mating connector housing |
| 331 | outer walls |
| 332, . . . | sub-housing |
| 333, . . . | surface |
| 334, . . . | wall |
| 34 | guiding surface |
| 35 | guiding pin |
| 36 | proximal region |
| 37 | orientation structure |
| 371 | tip |
| 38a, . . . | sheath element |
| 39, . . . | orientation structure |
| 310 | inner surface |
| 311 | retaining clip |
| 312, . . . | opening |
| 313, . . . | groove |
| 314 | web |
| 315 | inner surface |
| 316a, 316b | opening |
| 317 | end region |
| 318 | end surface |
| 319 | end surface |
| P | plugging direction |
| H | horizontal direction |
| V | vertical direction |
| AR | central axis |
| AS | central axis |
| LG | length of guiding surface |
| LR | length of lateral surface |
| R | rotation axis |
| E | extension direction |

1. A connector for establishing a plug connection with a mating connector by plugging together the connector with the mating connector along a plugging direction, the connector comprising at least one connector element that is arranged to establish a functional contact with a respective connector element provided on the mating connector;
wherein the connector further comprises:
at least one guiding element for guiding the plugging together of the connector with the mating connector along the plugging direction; and
at least one orientation structure,
wherein the guiding element has an elongated design and protrudes from the connector along an extension direction, and
wherein the at least one orientation structure is configured to provide a rotation lock with at least one complementary orientation structure provided on the mating connector with respect to a rotation of the connector relative to the mating connector upon connection of the connector and the mating connector.

2. The connector according to claim 1, wherein the at least one orientation structure is not completely rotationally symmetrical with respect to a rotation about a rotation axis extending centrally through the orientation structure.

3. The connector according to claim 1, wherein the at least one orientation structure of the connector is configured to form at least one of a positive fit and a force fit with the at least one orientation structure of the mating connector upon connection of the connector and the mating connector.

4. The connector according to claim 1, wherein the at least one orientation structure comprises a first orientation structure, wherein the first orientation structure is integrally formed on the guiding element.

5. The connector according to claim 4, wherein the first orientation structure is provided by means of at least one guiding surface, which guiding surface is configured to cooperate with a correspondingly shaped guiding surface provided on the mating connector.

6. The connector according to claim 1, wherein the at least one orientation structure comprises a second orientation structure, wherein the second orientation structure is designed as a recess extending into the connector or wherein the second orientation structure is designed as a sheath element protruding from the connector.

7. The connector according to claim 6, wherein at least one of i) one guiding element is arranged at least partly within the second orientation structure of the connector and ii) one or more guiding elements are laterally spaced apart from the second orientation structure of the connector.

8. The connector according to claim 6, wherein the guiding element extends beyond the second orientation structure when viewed along the extension direction.

9. The connector according to claim 1, wherein the connector further comprises at least one resilient element for resiliently mounting the connector on a support.

10. A connector system comprising a connector according to claim 1 and a mating connector, wherein the mating connector comprises at least one connector element that is arranged to establish a functional contact with the respective connector element provided on the connector, the mating connector further comprising:
at least one receptacle for receiving the at least one guiding element of the connector; and
at least one orientation structure that is designed complementary to the at least one orientation structure of the connector in order to provide a rotation lock with respect to a rotation of the connector relative to the mating connector upon connection of the connector and the mating connector.

11. The connector system according to claim 10, wherein the guiding element has one or more chamfers which are configured to slide along an inner surface of the receptacle upon connection of the connector and the mating connector so as to enable a guided receiving of the guiding element within the receptacle.

12. The connector system according to claim 10, wherein the second orientation structure of the connector and the receptacle of the mating connector in each case comprise free end regions having mutually corresponding inclined end surfaces, which inclined end surfaces enable a guided receiving of the guiding element within the receptacle.

13. The connector system according to claim 10,
wherein the at least one orientation structure of the mating connector comprises a first orientation structure, and
wherein said first orientation structure is a guiding surface provided on the receptacle and being correspondingly shaped with respect to the first orientation structure in the form of a guiding surface provided on the guiding element so as to enable a guided receiving of the guiding element within the receptacle.

14. The connector system according to claim 13, wherein at least one of:
i) the guiding surface of the receptacle is provided by means of a guiding pin arranged within the receptacle,
wherein the guiding pin is arranged offset with respect to a central axis of the receptacle, and
ii) the guiding pin is arranged in a proximal region of the receptacle.

15. The connector system according to claim 10, wherein the at least one orientation structure of the mating connector comprises a second orientation structure being provided by means of the receptacle itself.

16. The connector system according to claim 10, wherein the guiding element is electrically conductive and is configured for electrically contacting the receptacle on the mating connector, wherein a resilient contact element such as a contact lamella is arranged within the receptacle in order to establish an electrical contact; or
wherein the guiding element is non-conductive and serves solely for guiding.

17. The connector according to claim 9, wherein the resilient element is configured to compensate at least one of a vertical offset, a horizontal offset and an angular offset of the connector with respect to the mating connector upon connection of the connector and the mating connector.

18. The connector system according to claim 14, wherein the guiding pin extends through the clear width of the receptacle transversely with respect to the central axis.
